(19) United States
(12) Patent Application Publication
(10) Pub. No.: US 2003/0020360 A1
(43) Pub. Date: Jan. 30, 2003

(54) Hook commutator

(76) Inventor: Ulrich Luedtke, Karlsruhe (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/111,903

(22) PCT Filed: Aug. 16, 2001
(86) PCT No.: PCT/DE01/03152

(30) Foreign Application Priority Data
Aug. 30, 2000 (DE) 10042512.7

(51) Int. Cl. H02K 1/00

(52) U.S. Cl. 310/233

(57) ABSTRACT

In a hook commutator of the prior art, a soldered connection (15), which connects a carbon segment (13) to a lamination (11) can become detached, since in the hot staking process for securing the winding wire, heat is produced.

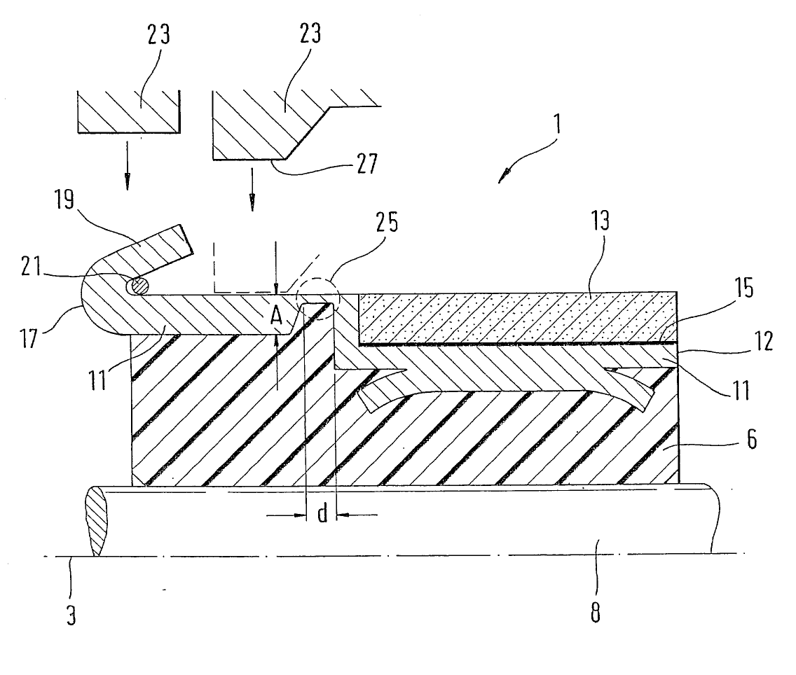

A hook commutator (1) of the invention has reduced thermal conduction in a region between the commutator hook (19) and the carbon segment (13), and thus the soldered connection (15) is protected against excessively high heat.

### PRIOR ART

The invention is based on a hook commutator for an electric-motor armature as generically defined by the preamble to claim 1.

A hook commutator for an electric-motor armature has laminations, to which the electric current is transmitted by carbon brushes. A winding wire of the rotatably supported electric-motor armature is electrically connected to the lamination. For producing the electric-motor armature with a hook commutator, among other provisions the winding wire is wrapped around one commutator hook each of the lamination of the hook commutator. In a required process of connecting the winding wire and the commutator hook, a constantly good mechanical and electrical quality of the connection of the commutator hook and winding wire is crucial. One connection process employed is known as hot staking. In this process the hook is deformed in such a way that the wire is clamped in place. An electrical voltage is then applied, so that the commutator hook and the wire heat up, among reasons because there is a contact resistance between the wire and the commutator hook. In this process, an insulation layer comes loose from the wire, and diffusion welding occurs between the wire and the commutator hook.

A carbon segment is often disposed on the lamination, as known from U.S. Pat. No. 5,925,961. The carbon segment is joined to the lamination by soldering, for instance.

In the heat development between the wire and the commutator hook in the connection process, in particular hot staking, this soldered connection between the carbon segment and the lamination can undesirably detach again at least in part, or the carbon segment can shift. This reduces the electrical properties, such as the transition resistance between the carbon and the lamination or the travel properties of a brush on a carbon surface, or shortens the service life of an electric-motor armature.

### ADVANTAGES OF THE INVENTION

The hook commutator of the invention, having the definitive characteristics of claim 1, has the advantage over the prior art that in a simple way the soldered connection between the carbon segment and the lamination is protected against excessive heating, and there is no impairment of the soldered connection.

Advantageous refinements of and improvements to the hook commutator defined by claim 1 are possible by means of the characteristics recited in the dependent claims.

It is advantageous if a cross-sectional area between the commutator hook and the carbon segment is reduced, because the thermal conduction in this region is reduced by the smaller cross-sectional area.

It is also advantageous to vary the region between the commutator hook and the carbon segment in such a way, for example by the means of the chemical composition or by varying the structure of the lamination, that the thermal conductivity is reduced.

For the connection process between the winding wire and the commutator hook, it is advantageous that a spacing between the commutator hook and the region with the lower thermal conduction is so great that an electrode can be accommodated there.

### DRAWING

In the drawing, which shows a hook commutator of the invention in axial cross section, one exemplary embodiment of the invention is shown in simplified form and explained in further detail in the ensuing description.

### DESCRIPTION OF THE EXEMPLARY EMBODIMENT

The drawing shows a hook commutator 1 of an otherwise known electric-motor armature in axial cross section. The hook commutator 1 has an axis of symmetry 3. A support body 6, for instance, is disposed on a rotor shaft 8 of the electric-motor armature. At least one lamination 11 of electrically conductive material is secured to this support body 6. This is accomplished for instance by spray-coating the lamination 11 at least partially with plastic, which for instance forms the material for the support body 6. However, the lamination 11 can also be secured to the support body 6 by other fastening methods.

On a portion of its one axial end 12, the lamination 11 has a carbon segment 13, which is secured to the lamination 11 by a soldered connection 15. However, the invention is not limited to a carbon segment 13 but instead encompasses any segments that are connected to the lamination 11 and are heat-sensitive. On the other axial end 17 of the lamination 11, a commutator hook 19 is formed. By means of the commutator hook 19, a winding wire 21 is electrically connected to the lamination 11. The material comprising the lamination 11, such as copper or a copper alloy, has a specific thermal conductivity [ ] and, perpendicular to the axis of symmetry 3 between the commutator hook 19 and the carbon segment 13, it has a cross-sectional area A.

In the connection process for connecting the commutator hook and the wire, such as the hot staking process, two electrodes 23 are applied to the lamination 11. One electrode is placed on the commutator hook 19, and the other electrode 23 is placed for instance between the commutator hook 19 and the carbon segment 13. In the connection process, heat is necessarily produced, which in a lamination of the prior art can cause the soldered connection 15 to separate at least in part.

To prevent this, in at least one region 25 of length d between the commutator hook 19 and the carbon segment 13, the thermal conduction is reduced during the connection process. There can be one or more such regions 25 between the commutator hook 19 and the carbon segment 13. In the case of the electrode 23 contacting the lamination 11, the region 25 is located between the carbon segment 13 and the next closest electrode 23.

At a given temperature difference, the thermal conduction through the region 25 is determined by the coefficient ([ ]*A/d); that is, the thermal conductivity in the region 25 is equivalent to this coefficient. By means of a suitable selection of at least one of these parameters, the soldered connection 15 can be protected against excessive heating.

This can be accomplished first, as shown in the drawing, by providing that a cross-sectional area A in the region 25 is reduced in the radial direction and/or perpendicular to the radial direction.

It is also possible to reduce the thermal conductivity [ ] in the region 25. This can be done for instance by means of a local variation in the chemical composition. By mixing particles that have a lower thermal conductivity in with the material of the lamination, the thermal conductivity of the lamination 11 is reduced in the region 25.

The thermal conductivity can also be reduced by means of a modified structure of the lamination 11 in the region 25, for instance by making the region 25 porous.

The length d of the region 25 can also be increased, in order to reduce the thermal conduction.

A variation in two or three parameters of the coefficient ([ ]*A/d) is also possible.

For the connection process, it is advantageous that the spacing between the commutator hook 23 and the region 25 is so great that an electrode 23 can be accommodated completely there without touching the region 25.

The possibility does exist of performing the hot staking process first, and then applying the carbon segment to the lamination 11 by means of soldering. However, this presents considerable problems compared to the standard method and in the case of winding wire 21 that is already contacted.

1. A hook commutator for an electric-motor armature, which has at least one lamination (11),
which on one axial end (17) has a commutator hook (19),
and which on the other axial end (12) has at least one carbon segment (13),
characterized in that
the lamination (11) has a cross-sectional area (A), in at least one region (25) of length (d) between the commutator hook (19) and the at least one carbon segment (13) perpendicular to the length (d), and
that the thermal conductivity in this region (25) is less than between the commutator hook (19) and the region (25).

2. The hook commutator of claim 1,
characterized in that
the cross-sectional area (A) in the region (25) of the lamination (11) is less than a cross-sectional area between the commutator hook (19) and the region (25).

3. The commutator hook of claim 1 or 2,
characterized in that
to reduce the thermal conductivity in the region (25) between the commutator hook (19) and the at least one carbon segment (13), the chemical composition of the material or the structure of the lamination (11) relative to the lamination region between the commutator hook (19) and the region (25) is varied, that the coefficient ([ ]*A/d) is reduced.

4. The commutator hook of one or more of claims 1-3,
characterized in that
a spacing between the commutator hook (19) and the region (25) is so great that an electrode (23) can be accommodated there completely with its contact face (27).
